(19) United States
(12) Patent Application Publication
(10) Pub. No.: US 2002/0128908 A1
(43) Pub. Date: Sep. 12, 2002

(54) System for conducting user-specific promotional campaigns using multiple communications device platforms

(76) Inventors: Brian E. Levin, Seattle, WA (US); Brent D. Brookler, Seattle, WA (US); Peter A. Loos, Seabeck, WA (US)

Correspondence Address: John F. Letchford, Klehr, Harrison, Harvey, Branzburg & Ellers, 260 South Broad Street, Philadelphia, PA, 19102, US

(21) Appl. No.: 09/952,535

(22) Filed: Sep. 14, 2001

Related U.S. Application Data
(63) Continuation-in-part of application No. 09/845,700, filed on Apr. 30, 2001.
(60) Provisional application No. 60/232,722, filed on Sep. 15, 2000.

(51) Int. Cl. G06F 17/60; G09B 3/00; G09B 7/00

(52) U.S. Cl. 705/14; 434/322

(57) ABSTRACT

A system for conducting promotional campaigns for multiple types of electronic communications devices. The promotional campaigns may include advertising and marketing campaigns involving the use of one or more of surveys, interactive games, contests, sweepstakes, location-based promotions, and tie-ins with brick-and-mortar outlets. The invention provides a process for (1) creating a promotional campaign, (2) simultaneously publishing the promotional campaign to users via a plurality of types of electronic communications devices, and (3) making the results of the promotional campaign available to the creator of the promotional campaign via communications devices of the creator's choice. Users of the system select the types of advertising and marketing campaigns in which they would be interested in participating. User-provided demographic, location, user preferences, device permissions settings and other user profile information enables creators of promotional campaigns to precisely direct those campaigns to receptive audiences and precisely monitor the success of those campaigns.

### CROSS-REFERENCE TO RELATED APPLICATION(S)

This application claims the benefit of U.S. Provisional Application No. 60/232,722, filed Sep. 15, 2000, and is a continuation-in-part of pending U.S. patent application Ser. No. 09/845,700, filed Apr. 30, 2001, entitled SYSTEM FOR CONDUCTING ELECTRONIC SURVEYS.

### FIELD OF THE INVENTION

The present invention relates in general to a system including apparatus and methods for conducting promotional campaigns. More particularly, the invention relates to a system for conducting user-specific electronic promotional campaigns that is simultaneously operable on many kinds of electronic communications devices, including wireless devices.

### BACKGROUND OF THE INVENTION

The concept of pervasive computing has emerged as a vision for the future where people will be able to connect and communicate at anytime from anywhere, using information devices and appliances. As opposed to the general-purpose personal computer (PC) of today, information devices are increasingly evolving into small, inexpensive consumer devices that are optimized to perform a specialized set of user-centric functions.

Technology is emerging which will permit marketers and advertisers to capitalize on the advantageous aspects of these devices. For instance, all of these devices, including the PC, are capable of enabling a user to interact with communications from an advertiser. And, wireless devices offer unique opportunities to marketers because of their portability and their capacity to identify the precise locations of their users in real time. These unique characteristics offer marketers new ways to tailor promotional campaigns and advertisements with demographic, geographic and temporal exactitude that were heretofore technologically impossible. Advertisers and marketers can engage in myriad promotional campaigns with selected segments of the population via a growing assortment of interactive electronic devices/platforms. Although no single system presently available has yet been capable of harnessing this potential, examples of the types of electronic promotional campaigns that might be conducted by marketers could conceivably include surveys, games, contests, sweepstakes, location-based promotions, and tie-ins with brick-and-mortar outlets, and so on.

In respect to surveys, for example, surveying public opinion and thoughts has been done for a long period of time. Generally, the techniques for soliciting opinions have improved with improving technology, starting with paper and mail and progressing to telephone surveys and solicitations. Currently, the proliferation of communications media and devices has greatly expanded the opportunities and ways by which to survey targeted groups for their opinions and thoughts. For example, even exclusively within the context of Internet surveying, there are multiple means by which users or respondents communicate with the Internet and can respond to Internet surveys. However, as presently conducted, Internet surveys are device-specific. That is, they are designed to be carried out using only a single one of several classes of Internet-compatible communications or interface devices, e.g., a personal computer (PC) or a wireless device such as a personal digital assistant (PDA) or cellular telephone (cell phone). This limits the scope of the survey to only one means of connectivity to a particular network. This may be problematic for a potential survey respondent who possesses only one type of communications device or who possesses more than one type of communications device but, because of preference, habit or necessity, tends to use one type of device more frequently, oftentimes considerably more frequently, than the others. Under these circumstances, such a potential respondent may not be captured within the pool of respondents whose input may be of importance to the survey administrator. This reduces the number of potential respondents that may be incorporated into the survey which, in turn, reduces the reliability of the survey results. Therefore, there is a need in the art for a system including methods and apparatus for conducting a survey with respondents having multiple means of connectivity to a particular network, whereby the respondents may participate in the survey regardless of the means by which they choose to connect to the network.

Similarly, a need also exists for a comprehensive system, including methods and apparatus for selectively targeting electronic promotional campaigns, survey-type, marketing-type or otherwise, to particular populations of electronic communications device users or to individual users based on information associated with the users' unique demographic profiles, instantaneous geographic locations, interests, buying habits, device and advertisement permissions settings and other parameters of interest to advertisers and marketers.

### SUMMARY OF THE INVENTION

The present invention provides a system including methods and apparatus for conducting promotional campaigns for multiple types of electronic communications devices. As used herein the term “promotional campaigns” shall be broadly construed to mean interactive advertising and marketing campaigns comprising the use of one or more of surveys, games, contests, sweepstakes, location-based promotions, and tie-ins with brick-and-mortar outlets as deployed by a pervasive marketing platform (PMP). The invention provides a process for (1) creating a promotional campaign, (2) simultaneously publishing the promotional campaign to users via a plurality of types of electronic communications devices, and (3) making the results of the promotional campaign available to the creator of the promotional campaign via communications devices of the creator's choice. Users of the system select the types of advertising and marketing campaigns in which they would be interested in participating. And, passive and/or active user-provided demographic, location, and device, campaign and/or advertisement permissions settings and/or other information enables creators of promotional campaigns to precisely direct those campaigns to receptive audiences across a variety of electronic devices and platforms while precisely monitoring the success of those campaigns.

The system according to the invention comprises a method for conducting user-specific promotional campaigns using mobile communications devices comprising:

(a) selecting one or more display formats appropriate for one or more technology platforms of electronic communications devices;

(b) selecting promotional information targeted to users of the communications devices;

(c) providing the promotional information to the communications devices for display by the communications devices in the appropriate display formats; and

(d) receiving end users' responses to stimuli present in the promotional information.

More specifically, for a typical promotional campaign, the process according to the invention comprises:

(a) creating a promotional campaign and placing the campaign into a first database as input data;

(b) wrapping each element of input data with desired markup language tags defined in a schema to provide a collection of data in a markup language-wrapped document;

(c) publishing the markup language-wrapped document parsed using the input data, wherein the input data is in the form of a collection of markup language-wrapped data, by parsing the markup language-wrapped data against the schema;

(d) sending the parsed, markup language-wrapped data in output defined style sheets to a plurality of types of communications devices via suitable communications networks;

(e) receiving user response data in a second database via suitable communications networks; and

(f) analyzing and publishing the retrieved data by wrapping the retrieved data in a desired markup language text.

Preferably, the markup language-wrapped data is further validated against a pre-defined schema. Additionally, the analyzed data is preferably further parsed against a second schema to enable the analyzed data to be accessed by at least one communications device type specified by a creator of the promotional campaign.

The invention further includes a publishing system for simultaneously publishing interactive promotional campaigns and collecting data from multiple communications device types. The publishing system enables a party to create a promotional campaign and publish the promotional campaign to an audience of potential respondents having multiple communications device types. Additionally, the publishing system gathers and analyzes the respondents' feedback and preferably makes the results available to the promotional campaign creator in one or more formats compatible with communications device types of the campaign creator's choosing.

The publishing system comprises an input database into which the promotional campaign creator inputs and stores all relevant information associated with a particular campaign (including, without limitation, question(s) to be answered or other interactive stimuli to be addressed by the respondents, the types of communications devices the creator chooses to receive the campaign, and other formation of interest to the campaign creator). The system further comprises a publishing engine for transmitting the promotional campaigns stored in the input database in the desired formats to the desired communications devices. Upon receipt of a promotional campaign, the respondents answer the questions posed therein (or otherwise interact with the promotional campaign in the manner desired by the campaign's creator) and transmit their responses to a results database and analysis engine of the publishing system. From the results database and analysis engine, the analyzed results are sent to the publishing engine where they may be retrieved by or sent to the campaign creators.

According to the present invention, therefore, promotional campaign creators can generate campaigns that can simultaneously reach multiple types of communications devices; respondents using a variety of communications devices may participate in a campaign; and, promotional campaign creators receive more complete and meaningful information than heretofore available using conventional single-device promotional campaigns.

To achieve these ends the present system comprises:

a database containing (1) display format information appropriate for a technology platforms of the communications devices, and (2) promotional information targeted to users of the communications devices; and

a server for providing communication between the database and the communications devices such that the communications devices display the promotional information in display formats appropriate for the technology platforms of the communications devices. Furthermore, the database includes: first storage means containing the display format information and second storage means containing the promotional information.

According to the invention, the promotional information is targeted to selected users based on information associated with the users' unique demographic profiles, instantaneous geographic locations, personal interests, buying habits, permissions settings and other parameters of interest to advertisers and marketers.

The present invention offers a powerful new direct marketing and customer acquisition model, especially for the mobile computing paradigm. This model involves using promotions such as games and surveys to build and leverage a profiled user base. Desirably, the platform is extensible so as to allow different branded private label promotions to be executed simultaneously on different devices and for different partners. As used herein, the term “partners” includes those persons or entities who share in the revenue or other proceeds generated by operation of the promotional campaign conducting system of the present invention. Partners may or may not provide content such as games, surveys or other promotional campaigns that may be offered by the PMP. At minimum, revenue may be derived from targeting messages and advertisements to the profiled users. The network preferably has a point scoring system to provide value to reward end users. The device platforms supported may include WAP phones, personal digital assistants running the PalmOS and PocketPC devices, Voice recognition applications using VoiceXML (TellMe, for example), HTML for the Web, J2ME (Java 2 Micro Edition) mobile phones and appliances, BREW (Qualcomm proprietary language Binary Runtime Environment for Wireless) and future environments.

Using the system according to the present invention, advertisers and marketers will have compelling opportunities to deliver highly targeted interactions to the profiled user base. These interactions could be ad messages, links to a site, special offers, or whole customized promotions directed to groups of users and individual users based on information profiles provided by users of the system. These interactions can be targeted, among other things, to user demographics, permission levels, current location, and express or implied purchase preferences based on a user's interests, buying habits and historic behavior within the system. The interactions can be tracked closely even if users leave the system network, to provide advertisers and marketers with detailed conversion information to track return on investment of their campaign. Advertisers are able to create customized campaigns across different promotions, on different devices, such as WAP phones, PDAs and voice enabled Internet applications.

The PMP technology of the present invention enables these functionalities, while remaining flexible and scalable for future device types, multiple partner structures, and emerging promotional opportunities. The architecture of the platform allows for different promotions with different rules and interactions to be created on a top application layer, while interfacing with a bottom application layer that contains all the user, advertiser and session information. This architecture allows for new promotions to be created and implemented as new ideas or market needs dictate.

Preferably, the system preferably includes a standard Application Programming Interface (API) whereby third party developers can create promotions and interactions to be deployed on the platform. This feature improves the platform by making more promotions available to end users while also creating a “turnkey” system for licensing the platform to potential licensees.

The feature set of the PMP thus serves as an end-to-end solution for direct marketing campaigns on stationary and mobile communications devices. The system allows clients to create different types of branded promotions and games and deploy them to different computing devices, (e.g., PCs, WAP phones, PDAs, Voice Interactive applications, and the Web) Once deployed, users can interact with the application using the device of their choice. These users' actions can be tracked, and combined with their profile information and device, campaign and/or advertisement permission levels, which allows ads to be precisely targeted to the users to increase the success or conversion rate of the ads. The system also manages, delivers, and tracks these ads and their responses from users, thereby allowing advertisers to maximize their return-on-investment (ROI).

In accordance with another important aspect of the present invention, an article of manufacture is provided which comprises a computer-readable medium embodying code segments for conducting an electronic promotional campaign. Such code segments generally include: a first code segment for enabling creation of an electronic promotional campaign; a second code segment for sending the campaign to a plurality of users having different types of electronic communications devices; and a third code segment for enabling access to user data generated in response to the campaign using at least one type of electronic communications device.

In accordance with a presently preferred embodiment, the code segments further include: a fourth code segment for storing the campaign on a first database; a fifth code segment for receiving the user data on a second database; and a sixth code segment for analyzing the user data.

The apparatus of the invention also includes a computer programmed with software to operate the computer in accordance with the invention. Non-limiting examples of a “computer” in this regard include: a general purpose computer; an interactive television; a hybrid combination of a general purpose computer and an interactive television; and any apparatus comprising a processor, memory, the capability to receive input, and the capability to generate output.

The article of manufacture of the invention comprises a computer-readable medium embodying code segments to control a computer to perform the invention. Non-limiting examples of a “computer-readable medium” in this regard include: a magnetic hard disk; a floppy disk; an optical disk, such as a CD-ROM, a CD-R, a CD-RW, or one using DVD standards; a magnetic tape; a memory chip; a carrier wave used to carry computer-readable electronic data, such as those used in transmitting and receiving electronic mail or in accessing a network, such as the Internet or a local area network (“LAN”); and any storage device used for storing data accessible by a computer. Non-limiting examples of “code segments” include computer programs, instructions, objects, software, or any means for controlling a computer.

Other details, objects and advantages of the present invention will become apparent as the following description of the presently preferred embodiments and presently preferred methods of practicing the invention proceeds.

### BRIEF DESCRIPTION OF THE DRAWINGS

The invention will become more readily apparent from the following description of preferred embodiments shown, by way of example only, in the accompanying drawings wherein:

FIG. 1 is a symbolic diagram of the essential components of a promotional campaign conducting system according to the present invention as embodied as a survey publishing system and the overall process enabled by the system;

FIG. 2 is a flowchart illustrating the process by which a surveyor using the system of FIG. 1 creates a survey;

FIG. 3 is a flowchart illustrating the process by which a survey created using the system of FIG. 1 is published to the respondents who will participate in the survey;

FIG. 4 is a flowchart illustrating the process by which a survey created using the system of FIG. 1 is implemented and the data is collected from the respondents;

FIG. 5 is a drawing showing the data analysis process used to analyze the data collected as shown in FIG. 4; and

FIG. 6 is a drawing showing the process by which the results of a survey created using the system of FIG. 1 are published to the party who originally requested the survey;

FIG. 7 is a drawing showing how user profile information may be imported and exported into and from the system according to the invention;

FIG. 8 is a drawing showing how updated response data is immediately available to be used by the system according to the invention in predicting the next interaction to be served to a user thereof;

FIG. 9 is a drawing showing the flow of a campaign building and tracking process for a marketing client using the system according to the invention;

FIG. 10 is a graphical user interface (GUI) window showing an initial phase of the interactive flow by which a marketing client might build a promotional campaign according to the present invention;

FIG. 11 is a GUI window showing a further phase of the interactive flow of FIG. 10;

FIG. 12 is a GUI window showing an example of how the system according to the present invention can be used to track certain aspects of a selected promotional campaign;

FIG. 13 is a drawing showing how user information may be gathered for reporting to the owner/licensor, system administrator, partners and clients of the system according to the invention; and

FIG. 14 is a drawing showing the primary and secondary application layers of the system according to the invention.

### DETAILED DESCRIPTION OF THE INVENTION

As used herein, the following terms shall have the meanings set forth below.

Schema is a document that defines tags.

Tags are definitions or titles of data specific for a particular user/surveyor agent.

Parser Engine parses data according to tags defined in the schema.

Style Sheet is an output specification corresponding to the display parameters of an output or communications device.

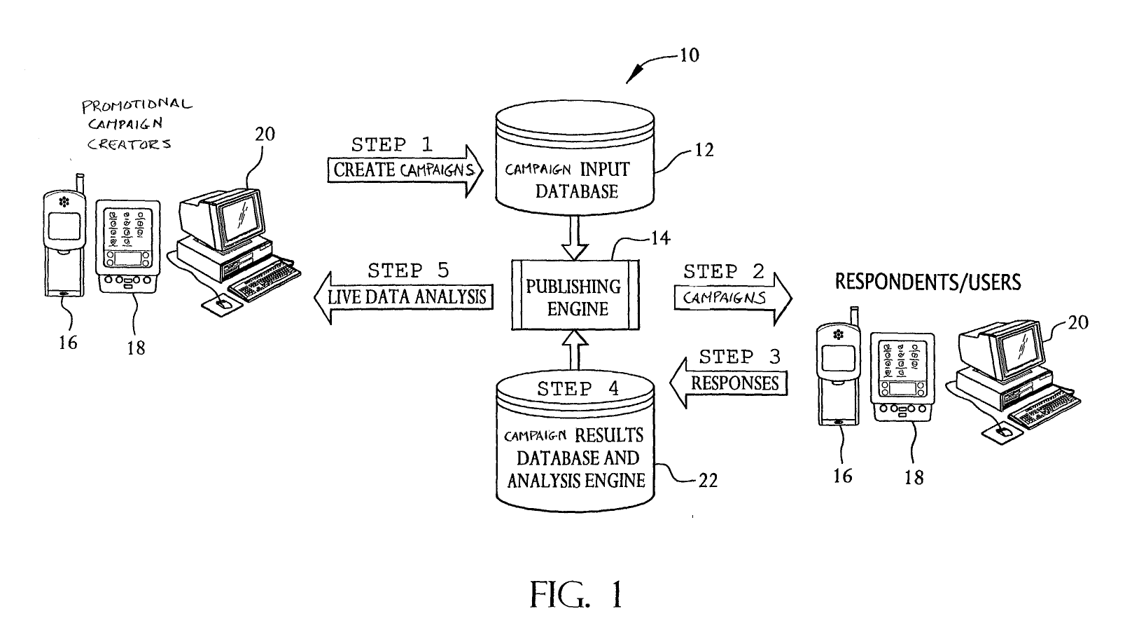

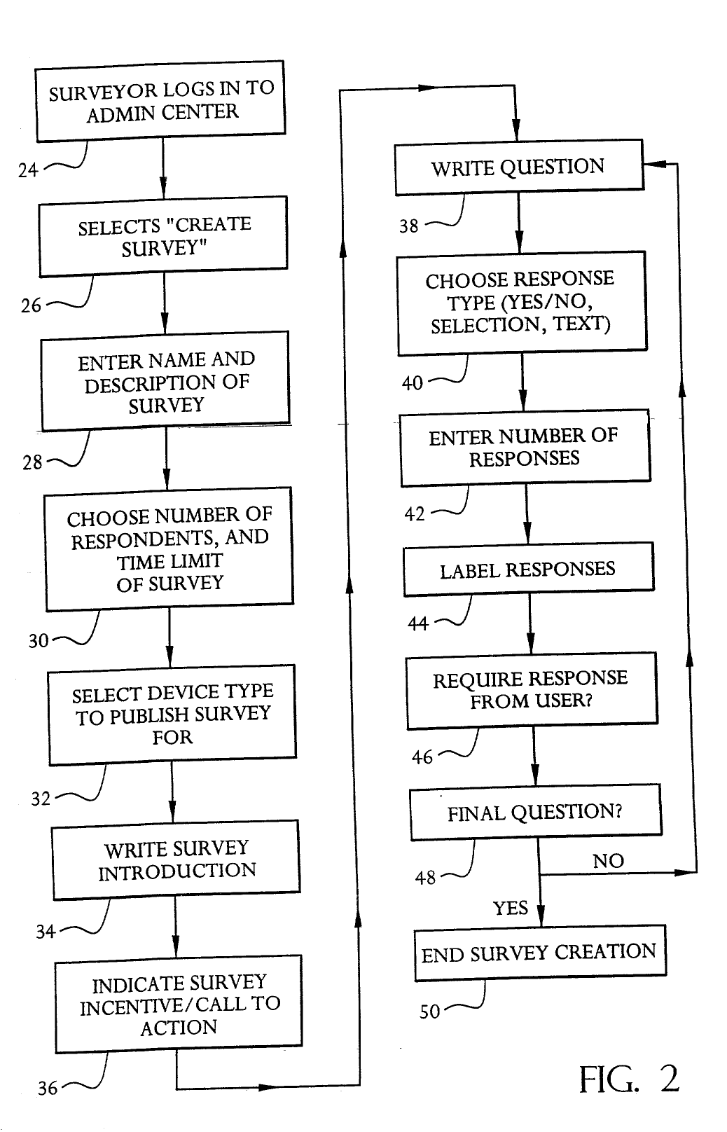

Referring to the drawings, wherein like or similar references designate like or similar elements throughout the several views, there is shown in FIG. 1 a promotional campaign conducting system according to the present invention. The system shown in FIG. 1, when considered in light of FIGS. 2-6, generally illustrates how the present invention would be used to conduct a promotional campaign in the form of an electronic survey, including creating, publishing, and collecting and analyzing data generated by the survey. It will be understood, however, that the present system may be used in analogous fashion to conduct any type of promotional campaign herein described.

In FIG. 1, the promotional campaign creators (in this case, surveyors) are depicted on the left side and the end users, or respondents, on the right side. The overall process is generally represented as follows:

Step 1: Promotional Campaign Creation: A campaign creator creates a campaign using a promotion publishing system which is generally indicated by reference numeral 10. During this step, the creator determines parameters or metrics appropriate for a particular promotional campaign. In the case of a survey, for example, the creator might establish, inter alia, the type of survey, the number of respondents desired (or, alternatively, the time limit of survey). At this point the campaign creator also establishes the desired communications device types on which to publish the campaign (PC, PDA, cell phone, etc.). Also, as will be more readily appreciated by reference to FIG. 2 and its corresponding description, it is at this stage that the campaign content, e.g., survey questions, is created by the surveyor. The campaign information is then stored in dedicated database tables in a campaign input database 12, where it can be accessed for later use.

Step 2: Campaign Publishing: This step involves taking the initial campaign data (such as survey questions, types, formats) and publishing it via suitable communications networks (wired or wireless) to various types of user/respondent computing or communications devices. Since there are many different device types, i.e., cell phone, PDA, PC, as well as future devices, that may be capable of implementing the present system, the formatting must be different for each type of device. As described hereinafter, a publishing engine 14 of promotion publishing system 10 will determine which type of respondent communications device (e.g., cell phone 16, PDA 18 or PC 20) is making a request to respond to a campaign. Thereafter, publishing engine 12 will publish the campaign over to communications device 16, 18 or 20 over an appropriate communications network (wired or wireless) in the appropriate format for that device.

Step 3: Campaign Implementation/Data Collection: At this step, the user responds to the survey or other campaign. The response data is transmitted by the respondent over the communications network and is collected at a campaign results database and analysis engine 22 of publishing system 10. This data includes not only the responses to the campaign queries and other stimuli, but user data, such as communications device type, and session information, such as the length of campaign, time of day, and so on.

Step 4: Data Analysis: Once the response data is collected from a respondent's device, the unprocessed data is stored in “raw data” database tables of the campaign results database. Statistical analysis is then performed on the raw data by the data analysis engine using stored procedures. The type of analysis is specified by the campaign creator and analyzed or processed data results are stored in dedicated “analyzed data” database tables.

Step 5: Analyzed Data Publishing and Reporting: Once the data has been analyzed in accordance with parameters prescribed by the campaign creator, reports and results are published by publishing engine 14. As specified by the campaign creator, publishing engine 14 preferably makes the campaign results and reports available for access by the creator via one or more communications devices (e.g., cell phone 16, PDA 18 or PC 20). The campaign results may be “pushed” by the publishing system server to the campaign creator in the manner known in the art. Alternatively, and preferably, the campaign results and reports may passively reside on the publishing system server where they may be “pulled” or retrieved by the campaign creator. In the latter case, publishing system 10 may be programmed to notify the creator via electronic mail message or otherwise that the campaign results are available for access. It will be understood that publishing engine 14 will publish different levels and depth of data according to the communications device specified by the creator to receive the data, e.g., a cell phone will only get high level reports, whereas a PC will receive detailed analysis.

FIG. 2 illustrates a survey creation process. This process preferably occurs in a secure administration environment, such as a password protected web site, where the surveyor can access all of its pertinent information, and build surveys to be presented to users. The survey creation process is outlined below.

Initially, at step 24, the surveyor logs in to the administration center's secure website, enters the appropriate user and password information to gain access to the publishing system 10 and, upon gaining such access, selects “Create Survey” at step 26. Thereafter, the surveyor determines all the variable factors of the survey. The variable factors include:

Name of survey (step 28)—quite simply, the title of the survey that can be used by both the surveyor and the respondents to refer to the survey.

Description of survey (step 28)—information provided by the surveyor for the purpose of describing the survey in a text field.

Number of respondents desired (step 30)—at this step, the surveyor selects how many survey responses it wants to limit the survey to. The surveyor may also select the option of “no limit.”

Time limit (step 30)—the surveyor selects an ending date/time for the poll.

Priority: time or number of responses (step 30)—the surveyor chooses which should take priority, the time limit of the survey or the number of responses.

Type of devices desired (step 32)—the surveyor selects what kinds of communications devices it wants to be able to respond to the survey. This will determine how and on which devices the poll will be published, e.g., cell phone, PDA, PC, as well as future devices.

Survey Introduction (step 34)—this enables the surveyor to input a narrative introduction to the survey including information such as the purpose of the survey and the sorts of information that the surveyor is seeking to collect. The survey introduction appears as text area that users will see on their communications devices when they begin to take the survey.

Survey Incentive/Call to Action (step 36)—at this point, if desired, the surveyor can create an incentive for a user who responds to the survey. It may be in the form of a text field to be entered by the client and can be presented as a discount, offer, or a uniform resource locator (URL) or hyperlink that can serve as a call to action.

Write question (step 38)—this is a text area that enables the surveyor to enter a question to be posed to the user.

Choose response type (step 40)—this step allows the surveyor to select the type of responses for the question, e.g., Yes/No, True/false, single selections, multiple selections, text boxes, numerical rating, numerical, Agree/Disagree scale, and so on.

Enter number of responses (step 42)—if the chosen response type is not Yes/No or True/False, then the surveyor will specify how many responses to choose from for that question.

Label responses (step 44)—this is a text area that enables the surveyor to provide descriptive text for the different responses based on the different question types.

Require response from user? (step 46)—this step enables the surveyor to specify whether a response to a particular question is mandatory.

Final question? (step 48)—if there are more questions to be created, the surveyor returns to write question step 38 and repeats steps 38-46). If there are no more questions to be added to the survey, the surveyor so indicates and the survey creation process terminates at step 50.

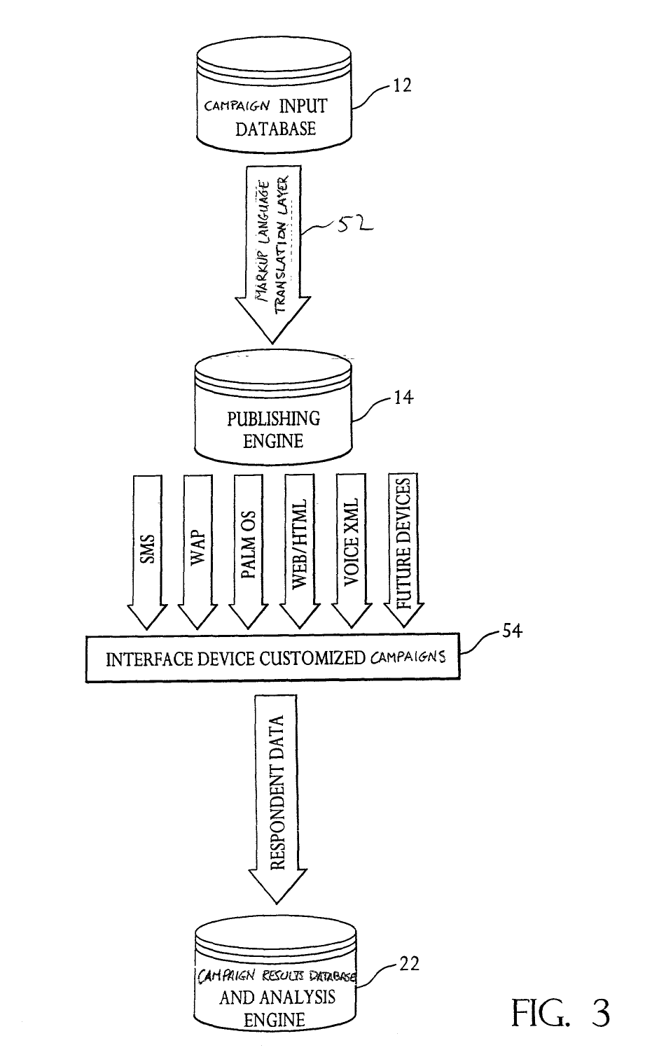

FIG. 3 illustrates the process of publishing a promotional campaign such as the survey created according to FIG. 2. Upon completion of creation of a campaign, the campaign parameters are stored in dedicated database tables in campaign input database 12. Publishing engine 14 thereafter publishes or “pushes” the campaign in the appropriate formats to the communications device types targeted for the campaign. To do so, publishing system 10 employs a markup language translation layer 52 that wraps each element of campaign input data with markup tags defined in a schema to provide a collection of data in a markup language-wrapped document. The markup language translation layer 52 preferably utilizes a plurality of markup language technologies in order to leverage the campaign data to multiple types of communications devices. According to a presently preferred embodiment, markup language translation layer 52 utilizes extensible markup language (XML), standard query language (SQL) and dynamic page creation technologies such as JAVA and PERL to achieve the desired objectives. It will be understood that markup language translation layer 52 may include any combination of the foregoing alone or in combination with one or more of hypertext markup language (HTML), wireless markup language (WML), user interface markup language (UIML) or other form of presently existing or yet to be developed standard generalized markup language (SGML) that may be used to realize the objectives of the present invention. Most preferably, the markup language translation layer 52 is preferably readily programmable or configurable to accommodate any markup languages that may be required to push data in campaign input database 12 in formats appropriate to all presently known and hereinafter developed communications devices.

According to a presently preferred embodiment, data collected during the campaign building or creation process is stored in the campaign input database 12 and translated to XML for optimal portability vis-a-vis presently available communications devices. Using publishing engine 14, the campaign creator may opt to publish the campaign immediately after creation and simultaneously to all types of devices. In the alternative, the creator may choose to delay the launch of the campaign or stagger the times at which the campaign information is published to the various communications devices selected for participation in the campaign. By way of example, publishing engine 14 may at present be configured to publish to cell phones using the wireless application protocol (WAP) (which incorporates WML), short messaging service (SMS) using the global system for mobile communication (GSM) or VoiceXML. Likewise, publishing engine 14 may also publish to computer browsers via HTML and to Palm® devices or other PDAs using PalmOS or other suitable PDA operating systems (or SMS) depending on where the creator wishes the campaign to be published.

Preferably, with one data set, all Internet appliances or communications devices are deployed ubiquitously. The following is a brief discussion of the formats having the broadest compatibility with presently available communications device technology.

WAP—WAP is primarily WML and WML script, but many different cell phones (User Agents) require slight modifications to the WAP standard. Preferably, markup language translation layer 52 includes a database of User Agents and their respective differences versus standard WAP. The present inventors have discovered that by using XML, customized style sheets may be created for each User Agent to ensure that all devices will work as designed.

HTML—For publishing to HTML, it is preferable to use HTML 3.2 to allow some retroactive compatibility with older versions of web browsers. In any event, HTML surveys should be 100% compliant with Netscape Navigator® 4.0 and later and Microsoft Internet Explorer® 4.0 and later, which presently account for more than 90% of the browser market.

PalmOS—For PalmOS, publishing engine 14 should be capable of publish using the current Palm-compatible formats including Web Clipping and Palm Query Application (PQA). Using XML or other SGML, it would preferable to create versions of PDA operating systems that are compatible with Palm® and other PDAs including ones using the PocketPC operating system.

Future Devices—As mobile computing continues to become more and more sophisticated and widespread, there will continually be new devices that the PMP will communicate and interact with. These devices will contain J2ME (Java Micro Edition) technology, BREW (Binary Runtime Environment for Wireless) and other technologies that are either in development now or will be developed in the future.

Once pushed to the desired communications devices, the formatted campaigns reside as customized campaigns 54 on the various devices. The respondents may then participate in the surveys and transmit their respondent data over the appropriate communication networks (wired or wireless) to the campaign results database and analysis engine 22.

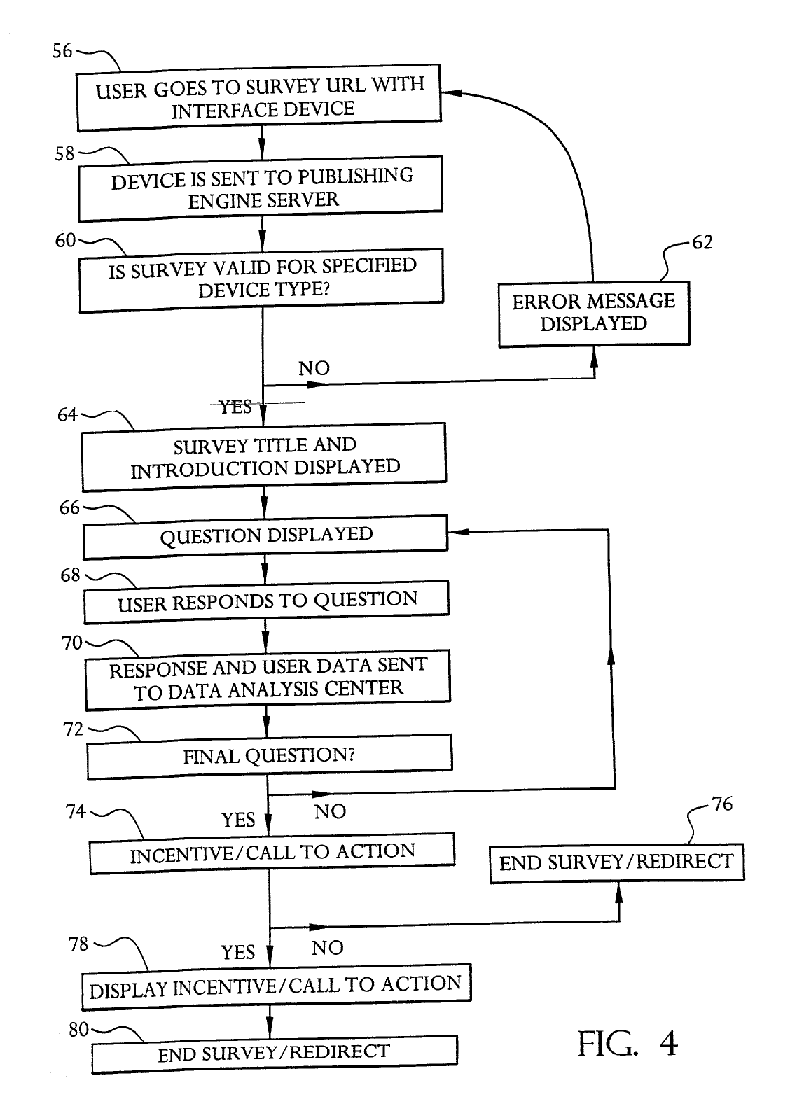

FIG. 4 illustrates the process by which respondents reply to the survey-type campaign. The process begins when the user, at step 56, directs his or her communications device to a URL associated with the stored survey. Data is collected in three distinct data streams during the survey implementation/data collection process—user profile, user session, and user response. To verify a particular device type, at step 58 data identifying the responding device is transmitted to the publishing engine 14. At the publishing engine, the device type is compared, at step 60, against a database table for acceptable device types. If the device is not found to be valid, an error message is displayed, at step 62, on the user's device at which point the user may again to participate in the survey at step 56.

If the user's device is determined to be valid, the survey begins. Initially, at step 64, the survey title and description are displayed, followed at step 66 by the first survey question 66. At step 68 the user responds to the first question and the response and user data is transmitted, at step 70, to the survey results and analysis engine 22. The survey questions and user responses thereto continue to be generated in turn until the final question is displayed and responded to at step 72. At this point, the system logic checks, at step 74, to determine whether the surveyor has not specified an incentive/call to action to motivate the user to respond to the survey. If not, the survey ends at step 76, and the user is optionally redirected to the application that the user was using, if any, prior participating in the survey. If so, the incentive/call to action is displayed at step 78 and the survey is terminated at step 80. Again, the user may be optionally redirected to the application that the user was using, if any, prior participating in the survey.

Session data is preferably gathered for each user that visits the survey, whether they personalize a user profile or not. Session data desirably preferably includes login time, click stream, time spent on each question, and logout time. Anonymous user profiles are preferably created for each new visit to the survey, unless the user establishes a personalized profile and logs into the survey with a password. All profiles are recorded as a unique numeric value and are used to correlate session data with unique visits. Personalized profiles can contain a variety of additional personal information including, without limitation, e-mail address, device address, zip code, age, gender and/or other relevant information.

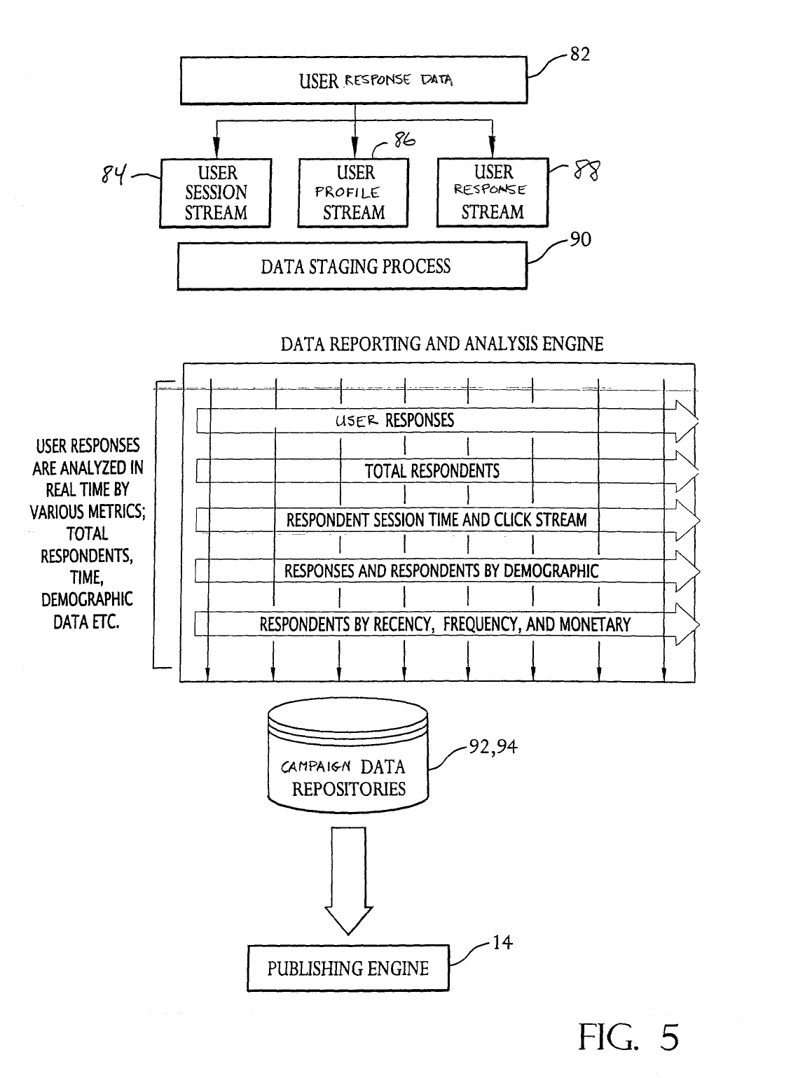

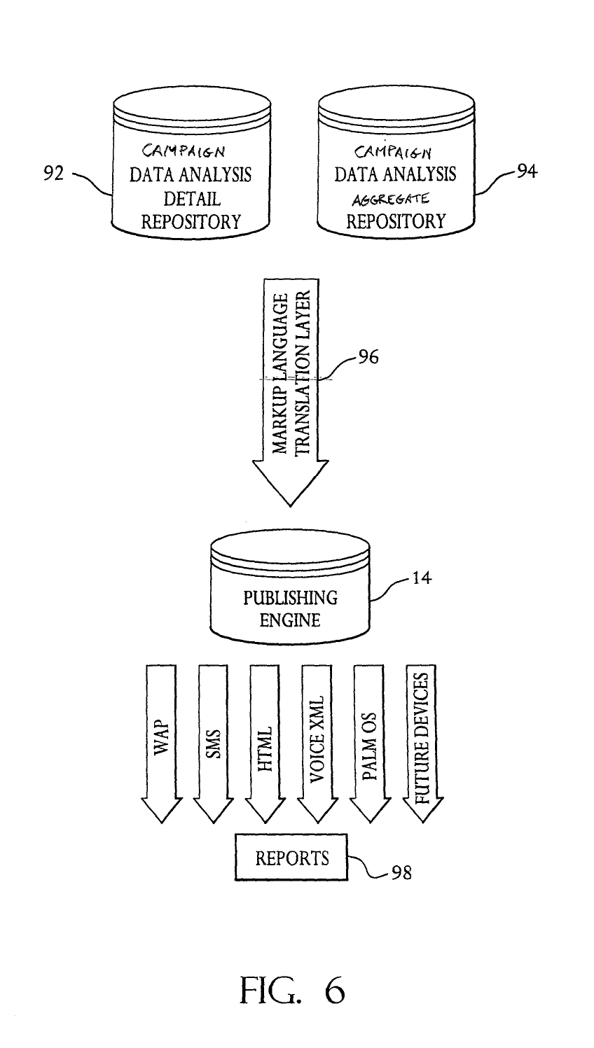

User responses to the campaign questions and other stimuli are collected and recorded with the unique numeric value of the user profile (anonymous or personalized) to allow for the correlation of user session, profile, and response data. The process of collecting campaign data from the user is represented in FIGS. 5 and 6.

FIG. 5 illustrates the process by which the data collected from campaign respondents is analyzed. The data analysis process is essential for providing value to the those who create the campaign in that it offers them real-time top-level results and detailed analysis and reporting.

Using data compression to speed analysis and delivery of results to publishing engine 14 ensures real-time results. The user response data 82, e.g., a completed survey, is transmitted to the publishing engine 14 in a user session stream 84, a user profile stream 86 and a user response stream 88. These data streams are compiled in a data staging process 90. At this point the analysis engine 22 analyzes the data in accordance with reporting requirements established by the campaign creator. The analysis engine 22 may analyze the response data in accordance with any criteria chosen by the campaign creator, for example, user responses (by questions or other stimuli), total respondents, respondent session time and click stream, responses and responses by demographic, and respondents by recency, frequency and monetary (discussed below). Depending on the device used to view published results, additional drill-down and drill-through requests are supported using common key elements in campaign data analysis detail and aggregate repositories 92 and 94, discussed below. The functions of the data staging process 88, analysis engine 22 and campaign data repositories 92,94 are as follows.

Data staging process—As the data is received from the three data streams 84, 86 and 88, it is immediately consumed by the data staging process 90. The data staging process 90 cleanses, compresses, and prioritizes the data received to ensure efficient processing by the analysis engine 22.

Analysis Engine—Campaign creator reporting requirements, which are established during campaign creation, are applied to the data received from the data staging process 90. Recognizing the priority of each piece of data, the analysis engine 22 produces new dimensions and updates existing dimensions as required, thereby producing detail and aggregate (summary) data streams to the campaign data analysis detail and aggregate repositories 92 and 94, respectively.

Data Repositories—Campaign data analysis detail and aggregate repositories 92,94 are inextricably linked through session, profile, and response data. Strong validation combined with indexing and performance tuning provides a reliable and efficient data store to be used by the publishing engine 14.

FIG. 6 illustrates the process by which the results of a campaign are reported to the campaign creator who requested them. The analyzed data that results from the campaign will be transmitted to the creator's administration area, where campaigns are created. The process is similar to the publishing of created campaigns to users, except the information is published to the creator's administration area of publishing engine 14. The process is outlined below.

The data contained in data repositories 92,94 is converted by a markup language translation layer 96 similar in content and function to markup language translation layer 52 discussed above. That is, markup language translation layer 96 wraps each element of campaign response data with markup tags defined in a schema to provide a collection of data in a markup language-wrapped document. Standard and/or customized reports 98 prescribed by the campaign creator may be provided to the creator in WAP, HTML, PalmOS, SMS, VoiceXML or other formats and style sheets suitable to the creator's specified communications device(s), whether presently existing or hereinafter developed. Standard reports may include one or more of the following: total number of respondents to the campaign, percentage of answers by question or other stimulus, average percentage of questions or other stimuli responded to, average session length, average time to respond to each question or other stimulus, total number of respondents who responded to a call to action, and total number of call to actions served.

Each of the reports may also be sorted by date/time, by RFM (R=Recency—how recently did the profile (user) visit; F=Frequency—how frequently has the profile visited; M=Monetary—how much in total has the profile spent with the campaign creator and/or provided benefit to the campaign creator), as well as by gender, gender by age group, age group, home zip code, location (cell), device type used to respond to the survey or other categories of interest to the campaign creator.

The following generally sets forth the overall process of the present invention as it would be used to conduct a promotional campaign using an XML format. More particularly, the process for conducting an XML-based promotional campaign comprises:

(a) creating a promotional campaign by writing survey campaign materials and placing the campaign materials into a first database as campaign input data;

(b) wrapping each element of campaign input data with desired markup language tags (e.g., XML tags) defined in a schema to provide a collection of data in a markup language-wrapped (e.g., XML-wrapped) document;

(c) publishing the markup language (e.g., XML) wrapped document, wherein the campaign input data are in the form of a collection of markup language-wrapped (e.g., XML-wrapped) data, by parsing the markup language-wrapped (e.g., XML-wrapped) data against the schema;

(d) sending the parsed, markup language-wrapped (e.g., XML-wrapped) data in output defined style sheets to a plurality of types of communications devices via suitable communications networks;

(e) receiving campaign response data in a second database via suitable communications networks;

(f) analyzing the received data; and

(g) publishing the received data by wrapping the received data in a desired markup language (e.g., an XML) document.

Preferably, the markup language-wrapped data are further validated against a pre-defined schema. Additionally, the analyzed data is preferably further parsed against a second schema to enable the analyzed data to be accessed by at least one communications device type specified by a creator of the promotional campaign.

The present invention may be used to conduct any type of promotional campaign herein described and in conjunction with any markup language formats currently known or developed in the future. The system according to the invention preferably includes an engine to allow for the management and delivery of not only survey-type but also game-type promotions simultaneously on multiple devices including WAP phones, PDAs, web browsers and voice applications. Promotions drive user activity and interest and therefore drive revenue by acquiring customers and generating revenue through advertising. For instance, a game-type promotion could be a sweepstakes with a poll on recent events or it could be an interactive, location-based game. The most successful promotions are those that are fun and compelling to wide audiences. The architecture of the present system is such that the core technology behind each promotion (e.g., session tracking, user profiling, advertising delivery and tracking, points scoring, and so on) does not change whereas the actual games or surveys driving the promotion may be widely disparate.

In order to build promotional games that are effective in attracting and retaining user attention, it is important to keep in mind the properties of a promotion that are necessary to do so. By combining and utilizing as many of the following factors as possible, the instant system can be used to build promotions that maximize user enjoyment.

Luck/Chance—This is very important in attracting users to promotions. If a player perceives that he or she has a chance at winning a valuable prize, then he or she will be willing to take the time and effort to participate in the promotion. These types of promotions include contests and sweepstakes, bingo-type games, betting games, guessing games for prizes (e.g., “guess the stock market”), etc. As such, the element of chance can be used as an incentive to users to fill out survey information or offer valuable personal information.

Skill/Knowledge—The present system can be used to build compelling promotions that attract users by allowing them to showcase their knowledge and skills. Games of this type include quiz-type trivia games, strategy games, memory games, and problem solving games. These types of promotions are best combined with multi-player competition. They also work best when a prize is rewarded for good performance in the game.

Competition—A key component of many popular games is competition. This can be competition between 2 or more players (friends or strangers) or player vs. computer. Competition promotions include trivia games, strategy games, such as chess or backgammon, and any other games where a scoring system is involved. Competition generates excitement in users, and also adds a viral element to the marketing strategy, i.e., players will want to recruit family members and friends to play against them.

Role Playing—These types of games involve a player assuming the identity of someone else. These can be fantasy-type games, involving warriors and princesses, or reality-type games, where players might become a music star, a Hollywood mogul, a professional athlete or other celebrity. These games are usually the most complex to develop because they typically incorporate competition, luck, and oftentimes skill and knowledge.

Location-Based—This is the most compelling facet of mobile promotions. With knowledge of the location information of the user, either from the user's profile information, or provided by the device, the nature of the promotions becomes much more interesting. This enables location-based promotions such as scavenger hunts, or “capture the flag” type games that can be played with multiple users over a localized area. This allows for integration of advertising from local merchants.

The promotion engine facilitates the development and deployment of games and other promotions. The promotions may be custom-built for each client. TABLE 1 lists representative although not limitative promotions that may be built according to the present invention, as well as several identifying characteristics associated with those promotions:

TABLE 1

| | | Skill/ | | | |
|---|---|---|---|---|---|
| Promotion/ | Luck/ | Knowl- | Compe- | Role | Location- |
| Game | Chance | edge | tition | Playing | Based |
| Surveys | | | | | X |
| Dating Game | X | | X | X | X |
| Trivia Games | | X | X | | |
| Sweepstakes | X | | | | |
| Scavenger Hunt | | X | X | | X |
| Secret Agent Game | X | | X | X | X |
| Rock Star Simulation | X | X | X | X | |
| Bingo | X | | | | |
| Betting Games | X | X | X | | |

Surveys

The system preferably comprises a tool to deploy surveys to multiple devices simultaneously while reporting and data analysis reside in a central database. An example of such a tool is described hereinabove and disclosed in copending U.S. patent application Ser. No. 09/845,700, filed Apr. 30, 2001, entitled SYSTEM FOR CONDUCTING ELECTRONIC SURVEYS, which is incorporated herein in its entirety by reference thereto. All results information is also made available instantly to multiple devices. The survey captures user feedback and processes it in real time. This is tool is especially useful if a client wants to capture user feedback information to users on multiple devices and deploy it immediately.

Examples of promotions in the form of games that may be deployed by the present system may include, without limitation:

Dating Game

An interactive dating game may be offered that is targeted to selected audiences, e.g., teenagers and the “Y Generation” or “Echo Boom.” This game is designed facilitate social interaction for users of client sites. Users can qualify to play the game by successfully answering a series of questions. Qualified candidates may then play before a larger interactive audience. Contestants may win prizes and the audience is preferably able to vote on contestants and win prizes.

Trivia Games

Trivia games may be employed where the user can earn points or play “head-to-head” with other players. Users can login and find other members to play against anytime, anyplace and anywhere.

Sweepstakes

Promotions might be offered whereby users can enter private label sweepstakes to win prizes such as money, travel packages, electronics and so on.

Scavenger Hunt

This is a location-based game that can be a real-time scavenger hunt.

Secret Agent

This game allows the user to play a secret agent involved in dangerous situations.

Rock Star

This game allows the user to role play as a rock star (although the game can be easily modified to permit the user to play some other type of celebrity).

Bingo

This game may be bingo or a bingo-like game.

Betting Games

These may include any type of betting game.

X Game

This is to represent all future games to be built on the PMP.

Profiling of end users is essential to the functionality of the PMP. A user profile includes the following components:

Login information—This is used to validate that the user is who they claim to be by utilizing basic user name and password authentication. As all devices enhance their capabilities, including the use of subscriber identity modules (SIM) cards and cookies, validation can be designed to occur seamlessly without requiring specific user interaction. For example, the application will be able to uniquely identify the user without the user having to enter a user name and password.

Validation of each user login is required in order to provide security for user data and allow for the customized user experience that was configured when the user built his or her profile. In addition to security and customization requirements, validation of a user allows profile and session interaction details to be correlated and analyzed. This is key to providing a customized user experience and delivery of advertisements to the appropriate audience.

Demographics—Demographic groups, characterized by age, income, sex, education, occupation, etc., are used to target advertising to niche markets. Utilizing demographics to target a user allows the appropriate promotions and advertisements to be served to the user based upon location, age group, or profession, and so on.

Preferences—User preference and permission data is used in conjunction with user demographic data to further target promotions and advertising campaigns. In this way, promotions and advertisements are prevented from delivery to a user who might otherwise fit the target demographic profile for a particular advertisement but who has specifically “opted-out” of the promotion or advertisement category.

Utilizing these three primary components of the profile system, the PMP can successfully target and deliver advertisements to end users, based on profile demographics, preferences, and permissions. Built and managed by the users and validated and integrated by the PMP system, the combination of these processes serve to enrich the user's experience.

The profile module of the PMP allows end users to create and manage their profile information. The primary component of user profile information is the user login name and password or personal identification number (PIN) that is used to access the PMP promotions. The profile details represent the secondary layer components of the user profile and include the following elements:

User address profiles—Users are capable of storing unlimited unique physical addresses, electronic addresses and phone numbers for each user profile, allowing users to create different address records for different locations such as home and work. In addition to supporting targeted direct mail advertising, address information provides location information (via area or postal code) to be used for advertising targeting.

Access device profiles—Users are capable of storing unlimited device sub-profiles for each user profile, users can specify their interaction preferences and permissions based upon each access device they may use (web browser, PDA, web enabled phone, etc.). Alternatively, users may apply their preferences and permissions globally across any device they may use.

Location profiles—Users are capable of storing unlimited location sub-profiles for each user profile and can specify their interaction preferences and permissions settings based upon each location from which they access the PMP. For business and other traveling users, location profiles add configuration beyond that provided by the base address profiles.

Demographic and preference profiles—Users are capable of storing unlimited demographic characteristics for each user profile without modifications to the system or database architecture That is, users can specify as few or as many demographic profile details as they wish. According to the invention, the customization of the end user experience is directly correlated to the number and breadth of demographic details specified by the user.

Permission level profiles—These provide a method for each user to indicate a desired level of permission with regard to advertising they he or she wishes to see and on which user access devices he or she wishes to see it. The application of the permission levels can be global for the user across all devices, promotions, and related advertising categories. In the alternative, it can be device, promotion and/or advertisement category specific.

Point banking profiles—In order to support the PMP point scoring model for rewarding users for their interactions (such as viewing an advertisement), point banking is available to each user for allowing them to manage their total point accumulation. A register is also provided to track where the user has exchanged points for rewards found within the system network.

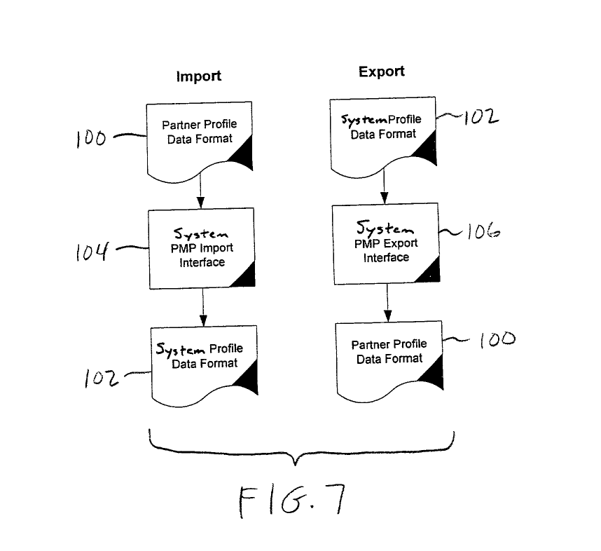

FIG. 7 shows how user profile information may be imported into and exported and from the system according to the invention. The ability to import and export user profile information from a variety of sources and formats is essential to advertisers who already have a large, profiled user base to which they wish to target advertising through the PMP. This allows the importing and exporting of system data without prerequisite knowledge of the system architecture and database structure. Preferably, this functionality is a standardized method for integrating partner profile data with the PMP, e.g., via a drag and drop interface. As shown in FIG. 7, on the “Import” side, a certain partner profile data format 100 may be converted into a system profile data format 102 and imported into the present system through a system PMP import interface 104. On the “Export” side, the process is reversed. That is, the instant system profile data format 102 may be converted and exported into a certain partner profile data format 100 through a system PMP export interface 106.

Each user interaction served by the PMP is determined by the intersection of user preferences, permissions, grouping and the promotion with which the user is interacting. As the user interacts with the PMP, each interaction response is recorded, thereby referencing related user profile and session information. The interaction response is then analyzed and the results are recorded in real time, updating implicit user preferences, permissions and groupings automatically.

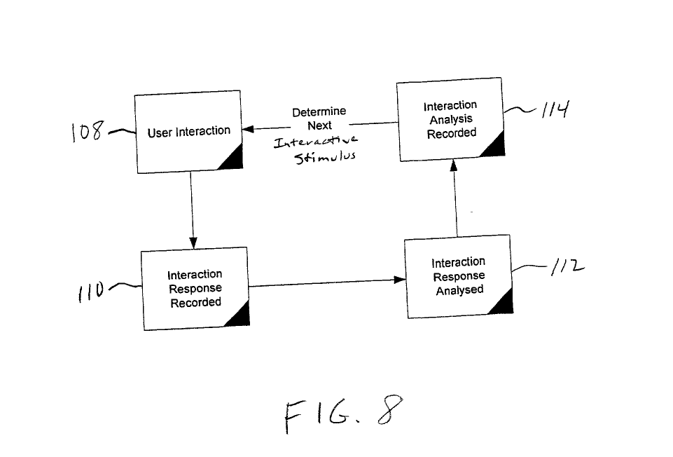

More particularly, FIG. 8 shows how updated response data is immediately available to be used by the system according to the invention in predicting the next interaction to be served to a user thereof. The system gathers live user data from various user applications and replicates user interactions in real time to the appropriate reporting databases. To illustrate, when a user interaction 108 results as a response to a question or other stimulus, the system records the interaction response at step 110. Thereafter, the results database and analysis engine analyzes the interaction response at step 112 and records the interaction analysis at step 114. The nature or type of recorded and analyzed response is then used by the system to intelligently determine and select the next interactive stimulus to be served to a user.

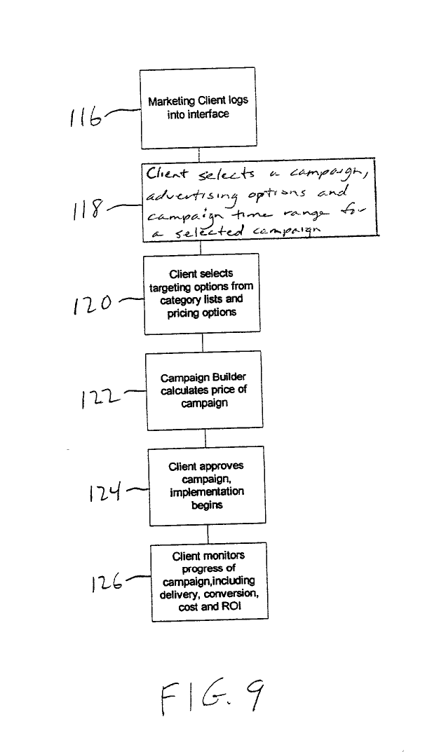

FIG. 9 is a drawing showing the flow of a campaign building and tracking process (referred to herein as “Campaign Builder”) for a marketing client using the system according to the invention. The Campaign Builder has administrative capabilities that facilitate ad management for partners of the system and partners of the system to:

indicate the promotions and advertisement types that can be made available to marketers;

assign pricing to different ads, from which a stakeholder such as an owner/licensor, partner or administrator of the instant system may draw a revenue share;

track the history of advertisement delivery across campaigns; and

track revenue from campaigns.

Additionally, partners of the system may assign values to loyalty points that are awarded to users by the system. This enables partners with their own loyalty programs to carry “system” points into their programs, by assigning them the same or corresponding values. Partners can also assign a point value for interactions in a promotion, such as viewing an ad, or providing information.

Using the Campaign Builder functionality of FIG. 9, marketing clients (advertisers) can develop and monitor their ad programs across any promotions that are active throughout the network. To use the Campaign Builder, a marketer logs initially onto the system interface at step 116. At step 118, the marketer selects a campaign, advertising options and time range for the selected advertising campaign. At step 120, the marketer can then select targeting audience options from demographic category lists as well as pricing options from pricing lists. Once steps 118 and 120 are completed, the Campaign Builder calculates the cost or price of the advertising campaign selected by the marketer at step 122. At step 124, the client approves the selected campaign and the campaign is implemented by the present system. Upon implementation of the chosen campaign, the marketer, at step 126, can monitor the progress and success of the campaign, including delivery, conversion cost and ROI.

More specifically, the Campaign Builder offers marketers the following advantages and features:

Promotion selection—Marketers view what promotions are running, on what devices, and the target audience of the promotion.

Ad type selection—Marketers view what different types of ad opportunities are available across promotions.

Inventory forecasting—The system may forecast the inventory of advertising impressions available based for each promotion based on past traffic trends and future traffic projections.

Ad creative storage—Marketers may be able to store and refer to their creative content for different ad types and device platforms.

Calculate costs—The system can show marketers the cost to reach each user based on the level of targeting and can calculate the cost of a campaign once the parameters are selected.

Reverse cost calculation—A marketer can determine the amount it is willing to spend on a campaign. Each component cost is preferably subtractable from that figure until the cost of the campaign has been reached.

Ad Types by device—This may be a list of the different opportunities that are available for promotions on different devices. In this regard, the system according to the invention preferably might include, inter alia, and by way of example only, the devices/platforms, ad types, specifications and comments shown in TABLE 2.

TABLE 2

| Device/ | | | |
|---|---|---|---|
| Platform | Ad Type | Specifications | Comments |
| WAP | Interstitial | 3 seconds long, | Between pages, during |
| | | with or without | load times |
| | | graphic | |
| | Link | Text link under | Placed into promotions |
| | | 144 chars, | after interactions |
| | | with URL | |
| | Sponsorship | n/a | Custom deals crafted |
| | | | on a case-by-case basis |
| | Point Redemption | n/a | Advertiser can specify |
| | Offers | | offers for users to |
| | | | redeem points |
| PalmOS | Interstitial | 3 seconds long, | Between interactions |
| | | with graphic | |
| | Banners | To be | Placed within pages, |
| | | determined | include link |
| | Link | Text only link | Placed after |
| | | | interactions |
| | Sponsorship | n/a | Custom deals crafted |
| | | | on a case-by-case basis |
| | Point Redemption | n/a | Advertiser can specify |
| | Offers | | offers for users to |
| | | | redeem points |
| Voice | Audio interstitial | 5-15 seconds | Between interactions |
| Applications | Audio ad with | 5-15 seconds | Call to action (dialed |
| | action | | number, voice |
| | | | response trigger) |
| | Audio | n/a | Custom deals crafted |
| | sponsorship | | on a case-by-case basis |
| | Point Redemption | n/a | Advertiser can specify |
| | Offers | | offers for users to |
| | | | redeem points |
| HTML | Interstitial | 3 seconds | Between interactions |
| | Banners | 468 × 60 pixels | Standard web banner |
| | Sponsorship | n/a | Custom deals crafted |
| | | | on a case-by-case basis |
| | Point Redemption | n/a | Advertiser can specify |
| | Offers | | offers for users to |
| | | | redeem points |

Among the most important aspects of the Campaign Builder is the ability to target ads based on user profiles. The following are among the categories to which advertisers are able to target messages using the present system:

Device Type—Advertisers can specify which types of devices they would like their messages to reach: WAP phones, PalmOS, Voice Recognition or HTML (as well as future devices).

User Personal Interest Preferences—This is a set of categories that identify a user's preferred activities and interests, such as sports, hobbies, entertainment, and the like, to which marketers can target their ads. The preferences are presented to the users who may be rewarded with loyalty points for providing their permissions and preferences.

User Demographics—Ads can be targeted to users' demographic characteristics, such as age, zip code, gender, city, state, area code, income, etc.

User Permissions—As relationships are developed with users, device, campaign and advertisement permission relationships can be developed. Permission relationships provide marketers with the ability to target messages to consumers that have explicitly requested to receive information in return for rewards.

Groups—Different groupings of categories can be made to maximize targeting effectiveness. For example, ads can be targeted to 30-year-old males in the Western U.S., or cell phone users under 50 interested in golf. With grouping of categories, targeted ad revenue can be expected to rise significantly.

Historical Information—The system has the ability to target ads based on historical usage patterns of an individual user or groups of users that have shown similar behavior or preferences. For example, if an ad has a historical conversion rate that is high for users that are between the ages of 18 and 25, then it or a similar ad can be targeted to that particular demographic group.

Priority—Ads can be targeted for priority of delivery to selected users. Thus, if certain ads have higher conversion rates with certain groups, then a priority can be set so that those targeted groups will have priority to receive those ads over other ads. This allows an owner/licensor, partner, administrator or other stakeholder in the system to maximize the revenue generated by targeting since ads that are higher priced can be set to a higher priority level.

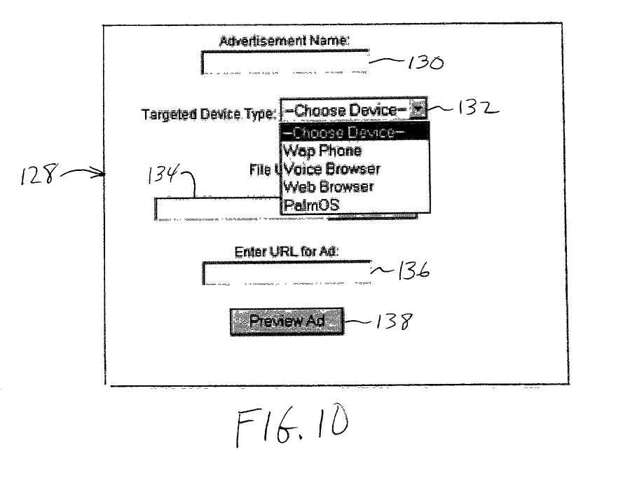

As seen in FIG. 10 a marketing or advertising client seeking to employ the present system to build, launch and track a promotional campaign typically encounters a first interactive graphical user interface (GUI) window 128. At window 128, the client inputs basic yet important information that the Campaign Builder uses to assemble a promotional campaign consistent with the advertiser's particular preferences.

For instance, at text box 130, the advertiser preferably inserts an advertisement name which is a label to be used by the system and the client for campaign identification and reporting purposes. At text box 132, the advertiser may then select from a drop-down menu or the like various targeted electronic communications device types (e.g., WAP phone, voice browser, web browser, PalmOS, etc.) upon which the advertiser desires to publish the campaign. At text box 134, which is partially obscured by the drop-down menu of targeted device type text box 132, the advertiser selects an appropriate file type to upload the campaign to the selected communications device type. For example, for a WAP phone, the advertiser could select a “.bmp” or other WAP-compatible file format. Other files, such as voice, graphics and/or audio files, may be selected to upload the campaign to the targeted communications devices consistent with the technological limitations of those devices.

At text box 136, the advertiser enters a uniform resource locator (URL) which the end users use to contact the advertising campaign on their communications devices. The URL is the address of a file (resource) accessible on the Internet. The type of resource depends on the Internet application protocol. For example, when using the World Wide Web's protocol, the hypertext transfer protocol (HTTP), the resource can be an HTML page, an image file, a program such as a common gateway interface application or Java applet, or any other file supported by HTTP. The selected URL is preferably accessible by the user by clicking on or otherwise actuating a hyperlink to an advertisement or other promotional mechanism. By actuating a button 138 or similar advertisement preview launching means, the user may preview the advertisement to assess the visual impression cast by the advertisement and the accuracy of the basic advertisement input parameters.

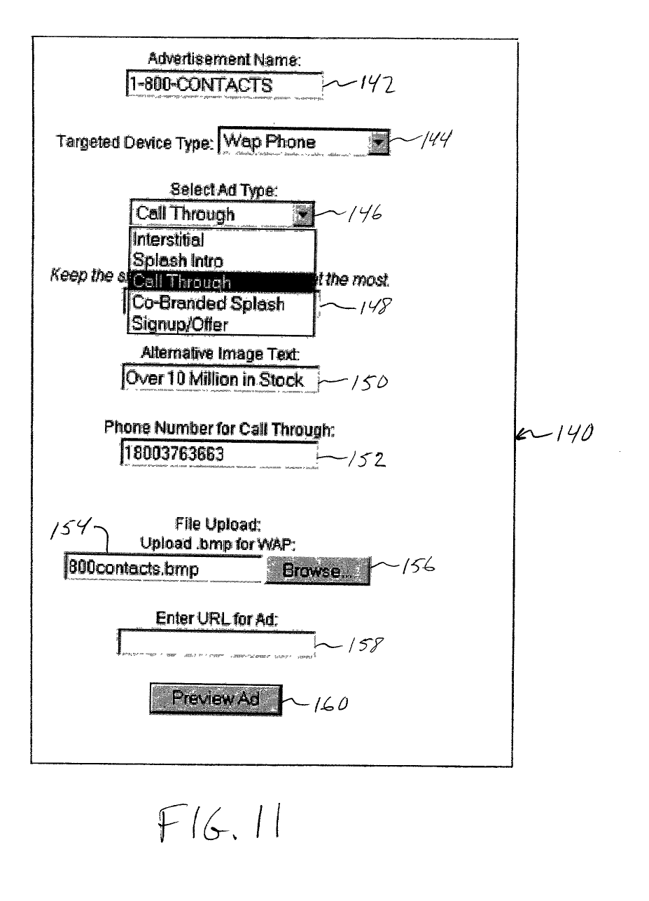

FIG. 11 illustrates a further phase of the interactive promotional campaign building flow of FIG. 10. Having provided the requisite information of window 128 of FIG. 10, the marketing or advertising client encounters a second interactive GUI window 140. At window 140, the client inputs additional information that the Campaign Builder uses to assemble an electronically publishable promotional campaign.

Like window 128, window 140 preferably requests the client to enter the advertisement name in a text box 142 and a targeted device type upon which to publish the promotional campaign in a text box 144. At text box 146, the advertiser selects the type of advertisement to be used in connection with the promotional campaign. It will be understood that the technological platform limitations of the targeted communications device selected at text box 144 determines the “type” of advertisements that may be selected (e.g., via a drop-down menu or similar mechanism) at text box 146 as well as the available options that may be offered at the subsequently discussed text boxes of window 140. For instance, if the selected communications device is a WAP phone, the advertiser might be able to choose, inter alia, an interstitial advertisement, a splash intro advertisement, a call through advertisement, a co-branded splash advertisement or a signup/offer advertisement. As used herein, an “interstitial” advertisement is one which is published for a predetermined period of time between certain other promotional campaign content such as a game or survey. A “splash intro” advertisement is an announcement-type advertisement such as “This game is sponsored by The Acme Corporation.” A “call through” advertisement is one which enables an end user to click on an advertisement which, turn, causes the system to telephonically dial and connect the user to the advertiser. A “co-branded splash” advertisement is a splash intro type advertisement announcing co-sponsorship of the promotional campaign by two or more entities. A “signup/offer” advertisement is a an advertisement type that offers the user some sort of benefit such as free merchandise, discounts, etc., in exchange for the user's participation in the promotional campaign.

Continuing, window 140 further includes an advertisement text or content text box 148 (which is partially obscured by the drop-down menu of select ad text box 146). The advertisement text input by the client into box 148 might be limited to some predetermined length and the box may be accompanied by instructions to that effect, e.g., “Keep the selected text at 50 characters at the most.” At text box 150 a client might input alternative/additioanl image text to be included in the advertisement. Exemplary, although certainly not limitative, text that could be input into text box 150 might be “Over 10 Million in Stock.”

If the targeted device type is a WAP phone or other device with telephonic capability, and a “call through” type advertisement is selected by the advertiser at box 146, then window 140 further includes a “phone number for call through” or similar text box 152 into which the client inputs the desired contact telephone number to be automatically dialed when a user clicks on an advertisement or otherwise suitably interacts with the promotional campaign. At text box 154, the advertising client inputs an appropriate file name for the file and file format for the promotional campaign and targeted communications devices. For example, for a WAP phone and in accordance with the file upload type selected at text box 134 of FIG. 10, the client inputs a file upload identifier, e.g., 800contacts.bmp. An associated browse button 156 is preferably provided to enable the advertiser to change the file format selection prior to publishing the advertisement.

And, like window 128 of FIG. 10, window 140 also preferably includes a URL window 158 into which the advertiser enters a URL that end users use to contact the advertising campaign on their communications devices, as well as a “Preview Ad” button 160 similar to button 138 of FIG. 10.

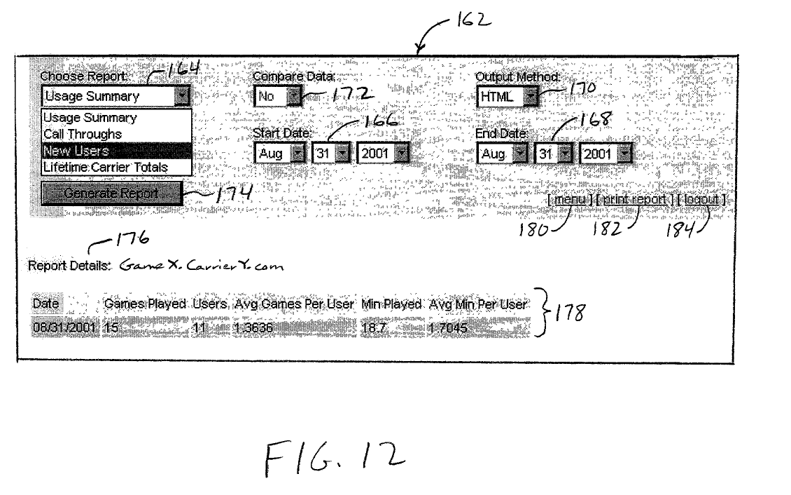

FIG. 12 is a GUI window showing an example of how the system according to the present invention can be used to track certain aspects of a selected promotional campaign. The content the window, identified generally by reference numeral 162, will vary depending the person or entity seeking access to data relating to the promotional campaign. In the illustrated example, window 162 represents the sort of campaign reporting information that would be of interest to an advertising client. As discussed below, the persons or entities who might be interested in various facets of the campaign reporting information include end users, advertising or marketing clients, owners/licensors, partners and system administrators. It will be understood that different persons or entities associated with the promotional campaign will be presented in window 162 with different campaign tracking information that is suitable for their particular purposes.

With this in mind, window 162 illustrates an example of a campaign tracking window that might be made available to an advertising client. In this context, window 162 preferably includes a text box 164 that enables the client to choose a type of report, e.g., “usage summary”, “call throughs” “new users”, “lifetime carrier totals”, etc., via a drop-down menu or the like. In window 162, the client may select desired start and end dates for analysis at “start date” and “end date” boxes 166 and 168, respectively. At box 170, the user may select campaign performance statistics for the technological format, e.g., HTML, from a drop-down menu or the like, by which the campaign was published. At box 172, the client may choose whether to compare the data, from a drop-down menu or the like, over a selected time frame, e.g., month-to-month, week-to-week, day-to-day, etc.

By actuating a “generate report” button 174 or similar device, the client may generate the report details for the selected type of report (such as “new users”) for the promotional campaign. Region 176 provides report details for the chosen campaign and chosen report type, which is arbitrarily identified herein as “GameX.CarrierY.com.” Region 178 provides certain generated statistics for the selected report. Preferably, window 162 also includes additional actuators that allow the report requester to select, for example, from a menu of other report options (at 180), print the report (at 182) and logout (at 184).

As technology advances and data transmission speeds increase, administrators of the present system will be able to improve the ads served on the network, especially to low bandwidth devices such as WAP phones. Future ad types will include audio ads and better graphics as they become available.

The most compelling opportunity to target content for mobile devices lies in targeting by location. Technology is commercially available to pinpoint a user's geographical location using a wireless device. This presents the ultimate opportunity in local advertising as merchant-clients using the present system can conduct localized promotions with customers identified as being in their immediate geographic vicinity.

Tracking user interactions through the PMP is crucial to satisfying partner, client, and user requirements alike. Throughout the system, all interactions are recorded and related directly to a session identifier (ID). This provides the opportunity to correlate end user interactions directly with the partner promotion, client campaign and user profile data used to create the customized interaction that was served to the user.

This foundation component of the PMP has four primary functions: track session interaction, analyze user interaction, manage platform activity and generate billing/reporting.

All user session interactions are recorded by the PMP, including promotion and campaign building activities completed by the partners and clients, and these interactions are related directly to a session ID. The following elements are captured with the PMP: User ID, Partner ID, Promotion ID, Campaign ID, Advertising ID, Click stream details, Session date and length, and User agent.

Although cookies are not used throughout all web-enabled devices, they do function within current desktop browsers and will most likely find use in all devices (wired and wireless). To support the currently available cookie-enabled devices/browsers, the session tracking application preferably interacts directly with cookies when and where appropriate, including the following functions: Generation, Setting, Reading and Updating.

Where cookies are not currently used, device-specific functionality may provide a different method in which to record a user identifier locally on the device. To support this current possible functionality (and future probability), a standard validation method is used to provide seamless interaction with the PMP regardless of user access device and device cookie functionality.

Session data is analyzed in real time as it is captured by the PMP, providing support for a truly interactive experience for partners, clients, users, and administrators alike. Data analysis may take place in the following areas:

Interactions served

Advertisements delivered (and related campaign data)

Advertisement clickthrough rate

Advertisement conversion rate

Advertisement costing

Page views

Unique visits

Unique visitors

Anonymous to profiled user conversion

Each of the foregoing is desirably available in a variety of groups and categories, including: system-wide, partners and promotions, clients and campaigns, and users and interactions.

User data analysis may have the following dimensions to allow the PMP to further predict the appropriate interaction to be served to unique users in the future:

Aggregate. Aggregate refers to analyzing past user interactions as a means to serving future advertising.

Trending. Trending refers to analyzing past user interactions to predict trends. These trends could define a user's characteristics and therefore increase advertising relevance.

Prediction. Prediction is the amalgamation of aggregate and trending data analysis as a means to offer the most accurate and relevant advertising message and advertising interaction.

As data analysis is completed by the system, results are recorded within a separate data warehouse to support system management, reporting, and billing applications. In addition, user data analysis is preferably integrated directly into the PMP profile management system to provide implicit, real-time updates to user preferences based on historical interaction analysis.

Management of the PMP is important to the stability and the provision of an “anytime, anywhere” environment for partners, clients and users. The primary purpose of the management tools is to provide a visual “dashboard” of system characteristics for administrators, such as user load, error conditions and system initiated responses, and system processes.

Produced as part of the PMP, the ability to manage platform activity is available through a variety of administrative user devices. As a result, the interface also utilizes the requisite user validation and tracking standards used throughout the platform for partners, clients and users.

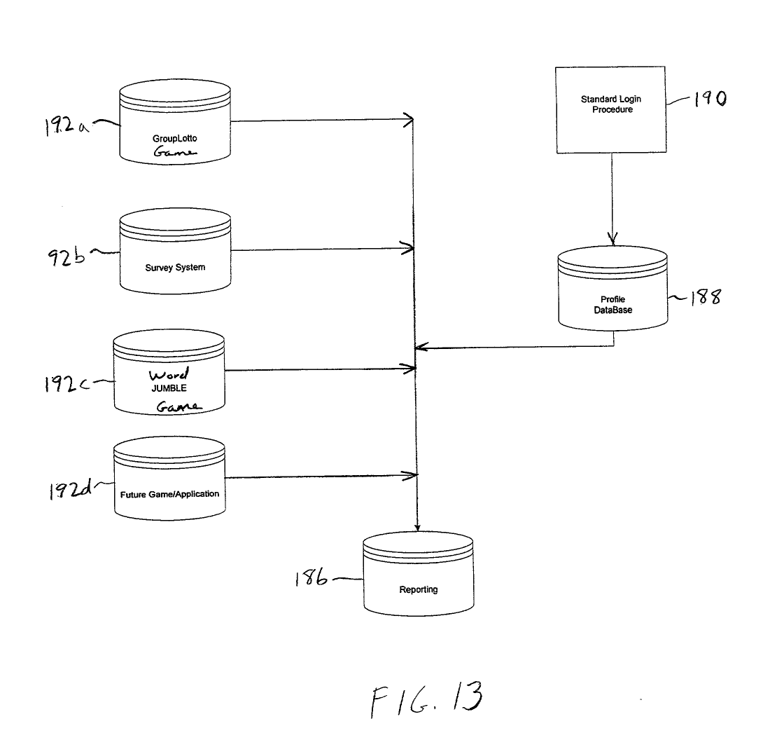

FIG. 13 is a illustrates how user information may be gathered for reporting to the owner/licensor, system administrator, partners, clients and even users of the system according to the invention. Reporting is a requirement for the system administrator, partners and clients. It provides a common and documented basis for pricing, partner/client reporting, and billing requirements. Standard reporting is available from the system based upon the user interaction analyses processed and warehoused within the PMP.

A reporting database 186 preferably receives, concurrently and in real time, aggregated flows of information from a user profile database 188, which is launched via a standard user login procedure 190, and one or more promotional campaign databases with which users are engaged, examples of which are identified by reference numerals 192a, 192b, 192c and 192d. That is, live data is gathered form the various applications and databases and replicated in real time to reporting database 186. Once the aggregated data is received by reporting database 186, it is compressed or flattened into reporting quality tables for transfer speed and efficiency. In this way, the system offers live reporting partner/client connections that are based on user login and session tracking.

Access to reporting may be limited based upon the specific level of reporting requirements: users, clients, partners and administrators.

Users preferably receive detail reports associated with their own profile.

Clients preferably receive detail reports associated with their respective advertising campaigns, related partner promotions, and related aggregate user analysis.

Owners/licensors, partners (and, possibly, administrators) preferably receive detail reports associated with their respective promotions, related client advertising campaigns, and related detail and aggregate user analysis.

Administrators preferably receive system-wide reporting capabilities to support business logistics requirements such as customer service, accounts receivable management, and system administration.

Future functionality for the tracking and reporting component of the PMP may include the following application extensions and APIs:

Extensions—Extensions provide additional functionality to the existing PMP and may include:

Direct application/hardware management from the administrative dashboard via CORBA compliant management architecture;

User device side java applications as permitted by device technologies;

Session management across user visits to third party sites; and

APIs—APIs allow system integration with third party packages in the following areas: advertising services and applications, finance/accounting services and applications, budgeting/forecasting services and applications, and CRM services and applications.

The present system is optimized by accommodating various operating systems, development languages, and application and web servers.

The PMP may be built on the most widely used open standards, including XML, SQL, Java, Perl and Visual Basic, with Java being the presently preferred core technology. All production application logic may be built in Java and deployed in Servlets, JavaBeans, Enterprise JavaBeans (EJB) and Java Server Page (JSP) pages. Preferably, an XML layer separates all application logic from presentation. A database of style sheets is preferably maintained for each device or “endpoint” that currently or will in the future connect to the system. Perl is preferably used for functions requiring intensive text manipulation in the background. The system may be run on Apache or any other suitable web server. Oracle 8i, ATG Dynamo, or other robust package may be used as the database and application server for the PMP. Although XML is the foundation for the instant system as it is presently constructed, concurrent and optimized applications on the Web, wireless devices, including cell phones, Palm devices, Windows CE devices, and voice applications in VXML are contemplated for use therein. In order to achieve this “simultaneous multiple modality,” XML schemas must be built for each promotion as well as relative style sheets for each device and end point.

Each application or promotion preferably has its own editor on the front-end; and, all back-end technology is preferably the same. Because day-to-day operations of games requires consistent updating and changing, the system desirably includes a tool to manage routine updates.

All applications adapted for the present system should be usable on the most widely used protocols and platforms. For wireless devices in the US and Europe, for example, WAP is the most widely used standard. For PDAS, Palm and Windows CE are the dominant players. For voice applications, TellMe Network Inc.'s voice application network or other suitable platform may be used for deploying voice applications.

Internet-capable cell phones may be integrated with the instant system using WAP. WAP is an XML-compliant language and is the worldwide de facto standard for publishing content to cell phones. Openwave Systems (formerly Phone.com), Nokia, Ericsson, Motorola, Microsoft and many other technology leaders are members of the WAP forum that defines the future of WAP. In Japan, NTT DoCoMo has more than 9 million subscribers on Internet cell phones using a competing standard called I-mode. I-mode is based on cHTML or compressed HTML. The present system, with its XML-centric architecture, should desirably incorporate a cHTML presentation layer to accommodate I-mode functionality in Japan and other countries that adhere to that standard.

The present system accommodates applications for PDAs on the PalmOS platform as well as the Windows CE platform. As these devices are a sort of middle ground between the Web browser and WAP phone, the instant system preferably includes an extra “layer” of functionality can be deployed to PDAs. The PDA has a larger screen than a WAP phone and has better ability to enter information from the user. As color screens and more ubiquitous wireless Internet capabilities evolve in this market, PDA sales will continue to grow and the present system will be positioned to expand its platform catalog to this growing class of devices.

With advances in voice recognition technology, it is now possible to gather data from users and allow users to navigate through content using voice commands. The present system deploys voice applications and promotions using the same core technology components as WAP and PDA presentations. By using a different “presentation” layer, the base platform is extensible to the emerging Voice Web. This technology is based on VXML or VoiceXML and was recently recognized by the World Wide Web Consortium (W3C) as a standard. As mentioned above, the present system may deploy TellMe's voice application platform or other suitable package such as IBM's ViaVoice SDK.

The data model contains two distinct layers of database design to maximize development and production efficiency and consistency—the foundation (or primary) and interaction (or secondary) data models.

The primary data model layer forms the broad foundation for the system environment. This layer supports the secondary layer above it by providing a common vision to bind application development and data management into one cohesive process. Deriving its broad data design elements from business plans and internal requirements for satisfying promotion/campaign tracking and reporting for partners/advertisers, it is formed largely of primary business concepts.

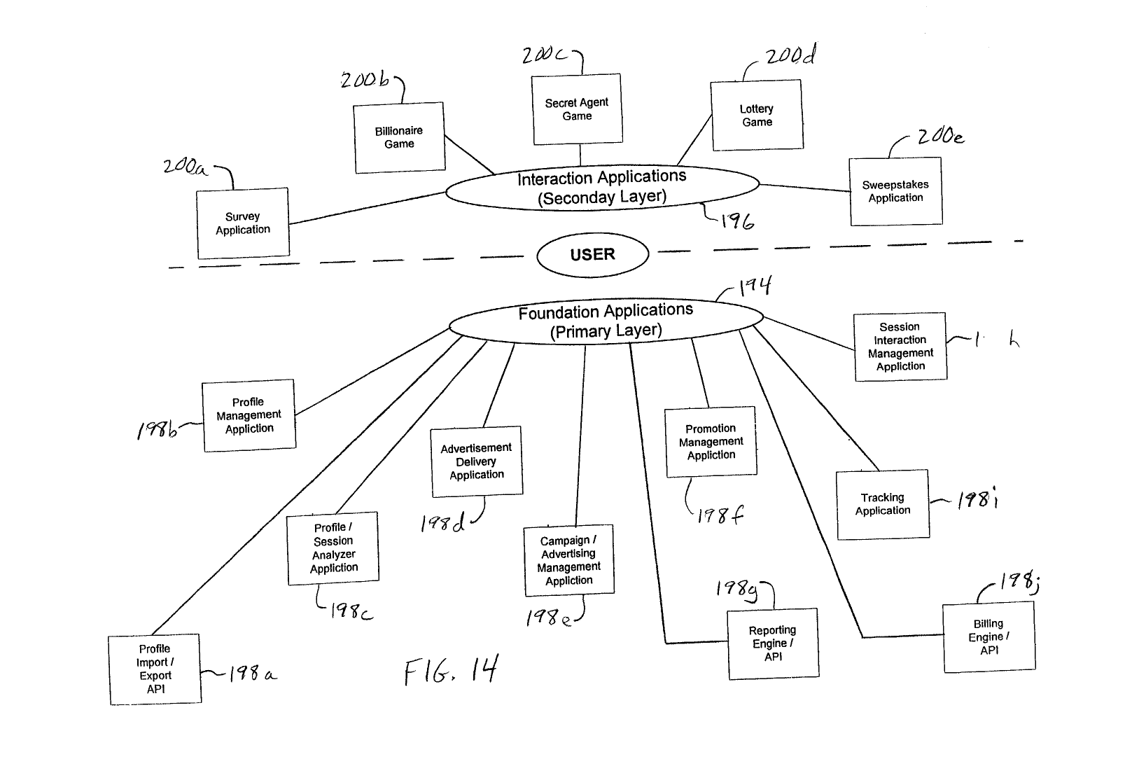

FIG. 14 is a drawing showing the primary and secondary application layers 194 and 196, respectively, of the system according to the invention. Primary applications and tables such as users, sessions, and interactions, identified by reference numerals 198a-198j, are defined within the primary layer 194 to ensure their seamless interaction with the secondary layer 196. In order to maintain a greater consistency in all applications built within and upon the system data model, system-wide and individual session settings are maintained through the data itself, thereby ensuring portability, scalability and reliability of the database objects.

Changes to the primary model represent fundamental alterations to the overall data architecture.

The secondary layer 196 is comprised of one or more user-interactive promotional campaign “content” applications, examples of which are identified by reference numerals 200a-200e. Secondary layer 196 forms the seal between independent, process-focused development and the primary layer 194 of the system data model. Secondary business concepts that come in the form of new marketing initiatives and custom promotion applications developed for partners are found within the secondary layer 196.

Focused on specific application functionality, there are many unique database applications within the secondary layer 196, each making full use of system and individual session settings and base table structures. This permits integration of the application with the system environment from within the database.

Changes to the secondary layer 196 are more flexible than changes made at the primary layer 194, permitting rapid promotional game development and enhancement without affecting other promotions, campaigns, and the foundation layer of the system data architecture.

Database access is preferably obtained through Java servlets built specifically for predicting and marshalling session-related data to the application server ahead of the user requests based on user history, preferences, and permissions. These servlets permit the client interaction to continue in real time while data analysis and aggregations take place transparently in the background. In addition, accessing the database objects in this standard manner aids in the rapid development and deployment of new promotional interactions with minimal modifications to the secondary data layer 196.

As the breadth of promotional applications within the PMP increases, these common database access servlets aid in simplifying extension of platform functionality and creation of APIs to third party applications, such as profiling, finance/accounting, and customer relationship management.

The present invention enables the building and supporting of a turnkey solution that provides the application performance, response, and utility that partners, clients and users require. A large portion of the PMP performance is governed by the database access methods described above and the hardware used for the database server. To this end, the hardware on which the database runs is desirably governed by the following rules:

(1) All production database objects, transaction logs, and data are preferably maintained on independent storage devices to ensure the maximum concurrent access to data.

(2) Aggregate data stores (used primarily for analysis and reporting) are preferably maintained within a separate database environment from that of the production database to provide maximum throughput without affecting the live environment.

(3) Triple-redundant database servers and database storage should be used for both the production and aggregate database requirements, to ensure 100% uptime.

Future functionality for the user profiling functions may include one or more of the following application extensions and APIs:

Extensions—to provide additional functionality to the existing PMP;

Point banking—extended to support conversions to other web portal point systems;

APIs—to allow system integration with third party packages in active directory, lightweight directory access protocol (LDAP), and other user profiling services and applications;

Customer relationship management (CRM) services and applications;

Demographic data resources, such as US Census Bureau; and

Personal organizer services and applications.

The compelling value proposition of the PMP lies in the ability of marketers to reach profiled users of the network with targeted advertising messages. To this end, there is provided a powerful toolset that manages all aspects of advertising and permission marketing over the platform. The “Campaign Builder” is a one-stop mechanism where clients can create and administer their campaigns to system network users. This web-based interface can provide marketers with a real-time view of the types of advertising products available on the system, including real-time inventory forecasts. It affords marketers a snapshot view of the different categories that can be targeted for messages, and let them cost and build custom campaigns to their business requirements. During and after the campaign implementation process, the marketer can view detailed reports on the campaign, including delivery, conversion, cost, and return on investment.

Although the invention has been described in detail for the purpose of illustration, it is to be understood that such detail is solely for that purpose and that variations can be made therein by those skilled in the art without departing from the spirit and scope of the invention as claimed herein.

What is claimed is:

1. A method for conducting a user-specific promotional campaign using a mobile communications device, said method comprising the steps of:
(a) selecting a display format appropriate for a technology platform of a mobile communications device;
(b) selecting promotional information targeted to a user of the mobile communications device; and
(c) providing said promotional information to the mobile communications device for display by the mobile communications device in said appropriate display format.

2. The method of claim 1 wherein step (c) further comprises providing said promotional information to the mobile communications device for display by the mobile communications device pursuant to an information profile provided by the user.

3. The method of claim 2 wherein said information profile comprises at least one permission setting.

4. The method of claim 3 wherein said at least one permission setting comprises a communications device permission setting.

5. The method of claim 3 wherein said at least one permission setting comprises a promotional campaign permission setting.

6. The method of claim 3 wherein said at least one permission setting comprises an advertisement category permission setting.

7. The method of claim 2 wherein said information profile comprises demographic information.

8. The method of claim 2 wherein said information profile comprises geographic location information.

9. The method of claim 2 wherein said information profile comprises personal interest information.

10. The method of claim 2 wherein said information profile comprises buying habits information.

11. A system for conducting a user-specific promotional campaign using a mobile communications device comprising:
a mobile communications device;
a database containing (1) display format information appropriate for a technology platform of said mobile communications device, and (2) promotional information targeted to a user of said mobile communications device; and
a server for providing communication between said database and said mobile communications device such that said mobile communications device displays said promotional information in a display format appropriate for the technology platform of said mobile communications device.

12. The system of claim 11 wherein said server provides said promotional information to said mobile communications device for display by said mobile communications device pursuant to an information profile provided by the user.

13. The system of claim 12 wherein said information profile comprises at least one permission setting.

14. The system of claim 13 wherein said at least one permission setting comprises a communications device permission setting.

15. The system of claim 13 wherein said at least one permission setting comprises a promotional campaign permission setting.

16. The system of claim 13 wherein said at least one permission setting comprises an advertisement category permission setting.

17. The system of claim 12 wherein said information profile comprises demographic information.

18. The system of claim 12 wherein said information profile comprises geographic location information.

19. The system of claim 12 wherein said information profile comprises personal interest information.

20. The system of claim 12 wherein said information profile comprises buying habits information.

21. A database for use in a system for conducting a user-specific promotional campaign using a mobile communications device, said database comprising:
first storage means containing display format information appropriate for a technology platform of a mobile communications device; and
second storage means containing promotional information targeted to a user of the mobile communications device, said promotional information being displayable by the mobile communications device in a display format appropriate for the technology platform of the mobile communications device.

22. The database of claim 21 wherein said promotional information is directed to a user of the mobile communications device pursuant to an information profile provided by the user.

23. The database of claim 22 wherein said information profile comprises at least one permission setting.

24. The database of claim 23 wherein said at least one permission setting comprises a communications device permission setting.

25. The database of claim 23 wherein said at least one permission setting comprises a promotional campaign permission setting.

26. The database of claim 23 wherein said at least one permission setting comprises an advertisement category permission setting.

27. The database of claim 22 wherein said information profile comprises demographic information.

28. The database of claim 22 wherein said information profile comprises geographic location information.

29. The database of claim 22 wherein said information profile comprises personal interest information.

30. The database of claim 22 wherein said information profile comprises buying habits information.

31. A method for conducting an electronic promotional campaign, said method comprising the steps of:
creating an electronic promotional campaign;
sending said campaign to a plurality of users having different types of electronic communications devices; and
accessing user data generated in response to said campaign using at least one type of electronic communications device.

32. The method of claim 31 further comprising accessing said user data using a plurality of types of electronic communications devices.

33. The method of claim 31 further comprising storing said campaign on a first database and receiving said user data on a second database.

34. The method of claim 33 further comprising analyzing said user data prior to said step of accessing.

35. The method of claim 34 wherein said step of analyzing comprises analyzing said user data in accordance with criteria established by a creator of said campaign.

36. The method of claim 31 further comprising providing said promotional information to the communications devices for display by the mobile communications devices pursuant to information profiles provided by the users.

37. The method of claim 36 wherein said information profiles comprise at least one permission setting.

38. The method of claim 37 wherein said at least one permission setting comprises a communications device permission setting.

39. The method of claim 37 wherein said at least one permission setting comprises a promotional campaign permission setting.

40. The method of claim 37 wherein said at least one permission setting comprises an advertisement category permission setting.

41. The method of claim 36 wherein said information profiles comprise demographic information.

42. The method of claim 36 wherein said information profiles comprise geographic location information.

43. The method of claim 36 wherein said information profiles comprise personal interest information.

44. The method of claim 36 wherein said information profiles comprise buying habits information.

45. A method for conducting an electronic promotional campaign, said method comprising the steps of:
(a) creating a promotional campaign and placing said campaign into a first database as input data;
(b) wrapping each element of said input data with markup language tags defined in a schema to provide a collection of data in a markup language-wrapped document;
(c) publishing said markup language-wrapped document, wherein said input data is in the form of a collection of markup language-wrapped data, by parsing said markup language-wrapped data against said schema;
(d) sending said parsed, markup language-wrapped data in output defined style sheets to a plurality of types of communications devices via suitable communications networks;
(e) receiving user response data in a second database via suitable communications networks; and
(f) publishing said received user response data by wrapping said received user response data in a desired markup language document.

46. The method of claim 45 further comprising analyzing the received user response data by wrapping the received data in a desired markup language text prior to publishing the received user response data.

47. The method of claim 45 further comprising accessing said received user response data using at least one type of electronic communications device.

48. The method of claim 45 further comprising accessing said user response data using plurality of types of electronic communications devices.

49. The method of claim 45 wherein said step of accessing is performed by a creator of said campaign.

50. The method of claim 45 further comprising analyzing the received user response data prior to publishing the received user response data.

51. The method of claim 45 wherein said markup language-wrapped data are further validated against a pre-defined schema.

52. The method of claim 45 wherein said received user response data is further parsed against a second schema to enable the analyzed data to be accessed by at least one communications device type specified by a creator of the campaign.

53. The method of claim 45 wherein said markup language is extensible markup language.

54. The method of claim 45 wherein said communications devices display said parsed, markup language-wrapped data in said output defined style sheets pursuant to information profiles provided by users of said communications devices.

55. The method of claim 54 wherein said information profiles comprise at least one permission setting.

56. The method of claim 55 wherein said at least one permission setting comprises a communications device permission setting.

57. The method of claim 55 wherein said at least one permission setting comprises a promotional campaign permission setting.

58. The method of claim 55 wherein said at least one permission setting comprises an advertisement category permission setting.

59. The method of claim 54 wherein said information profiles comprise demographic information.

60. The method of claim 54 wherein said information profiles comprise geographic location information.

61. The method of claim 54 wherein said information profiles comprise personal interest information.

62. The method of claim 54 wherein said information profiles comprise buying habits information.

63. Apparatus for conducting an electronic promotional campaign, said apparatus comprising:
a first database for storing an electronic promotional campaign comprised of campaign input data;
a publishing engine for sending said campaign to a plurality of users having different types of electronic communications devices via suitable communications networks; and
a second database for receiving user response data from said electronic communications devices via suitable communications networks, wherein said publishing engine further publishes said user response data for access by at least one type of electronic communications device.

64. The apparatus of claim 63 further comprising means for analyzing said user response data prior to publishing by said publishing engine.

65. The apparatus of claim 64 wherein said analyzing means analyzes said user response data in accordance with criteria established by a creator of said campaign.

66. The apparatus of claim 63 wherein, prior to sending said campaign to a plurality of users, said publishing engine wraps each element of said campaign input data with markup language tags defined in a schema to provide a collection of data in a markup language-wrapped document.

67. The apparatus of claim 63 wherein, prior to publishing said user response data, said publishing engine wraps each element of said user response data with markup language tags defined in a schema to provide a collection of data in a markup language-wrapped document.

68. The apparatus of claim 66 wherein said markup language is extensible markup language.

69. The apparatus of claim 67 wherein said markup language is extensible markup language.

70. The apparatus of claim 63 wherein said communications devices display said campaign input data pursuant to information profiles provided by users of said communications devices.

71. The apparatus of claim 70 wherein said information profiles comprise at least one permission setting.

72. The apparatus of claim 71 wherein said at least one permission setting comprises a communications device permission setting.

73. The apparatus of claim 71 wherein said at least one permission setting comprises a promotional campaign permission setting.

74. The apparatus of claim 71 wherein said at least one permission setting comprises an advertisement category permission setting.

75. The apparatus of claim 70 wherein said information profiles comprise demographic information.

76. The apparatus of claim 70 wherein said information profiles comprise geographic location information.

77. The apparatus of claim 70 wherein said information profiles comprise personal interest information.

78. The apparatus of claim 70 wherein said information profiles comprise buying habits information.

79. A computer-readable medium embodying code segments for conducting an electronic promotional campaign, the code segments comprising:
a first co de segment for enabling creation of an electronic promotional campaign;
a second code segment for sending the campaign to a plurality of users having different types of electronic communications devices; and
a third code segment for enabling access to user data generated in response to said campaign using at least one type of electronic communications device.

80. The computer-readable medium of claim 79 further comprising:
a fourth code segment for storing the campaign on a first database; and
a fifth code segment for receiving the user data on a second database.

81. The computer-readable medium of claim 80 further comprising a sixth code segment for analyzing the user data.

82. A method for conducting an electronic promotional campaign, said method comprising the steps of:
receiving a user response to an interactive stimulus provided in said campaign;
recording said response;
analyzing said response; and
determining a subsequent interactive stimulus to be served to a user based on said analyzed response.

83. A method for conducting an electronic promotional campaign, said method comprising the steps of:
selecting, by an advertising client, an electronic promotional campaign for display on a plurality of electronic communications devices supported by a plurality of technology platforms;
implementing the selected campaign; and
monitoring the implemented campaign.
